(19) United States
(12) Patent Application Publication
(10) Pub. No.: US 2025/0249587 A1
(43) Pub. Date: Aug. 7, 2025

(54) CONTROL DEVICE, ROBOT SYSTEM, CONTROL METHOD, AND RECORDING MEDIUM

(71) Applicant: NEC Corporation, Minato-ku, Tokyo (JP)

(72) Inventors: Kei Takaya, Tokyo (JP); Rin Takano, Tokyo (JP)

(73) Assignee: NEC Corporation, Minato-ku, Tokyo (JP)

(21) Appl. No.: 18/855,010

(22) PCT Filed: Apr. 14, 2022
(86) PCT No.: PCT/JP2022/017766

§ 371 Date: Oct. 8, 2024

(51) Int. Cl. B25J 9/16

(52) U.S. Cl. CPC B25J 9/1669; B25J 9/161; B25J 9/1682

(57) ABSTRACT

A controller sets a condition for a face of a target object according to an expression using a direction in which the target object is grasped and a direction in which a posture of the target object is defined, the condition being included in constraint conditions for deciding the posture of the target object and a movement path of the target object and related to a grasp of the target object, release of the grasp of the target object, or a switching of the target object from one robot arm to another robot arm. The controller controls at least one of a first robot hand and a second robot hand so that the target object is grasped, the grasp of the target object is released, or the target object is switched from one robot arm to another robot arm using the face decided based on the condition.

### TECHNICAL FIELD

The present disclosure relates to a control device, a robot system, a control method, and a recording medium.

### BACKGROUND ART

Robots are used in various fields such as logistics. Some robots may operate autonomously. Patent Document 1 discloses technology related to a device for generating a trajectory plan in which the tip of a robot arm moves from a start point to an end point as the related art. Moreover, Patent Documents 2 and 3 disclose technology related to a robot system for grasping a target object as the related art.

### PRIOR ART DOCUMENTS

### Patent Document

Patent Document 1: Japanese Unexamined Patent Application, First Publication No. 2021-079482
Patent Document 2: Japanese Publication No. 6996963
Patent Document 3: Japanese Unexamined Patent Application, First Publication No. 2017-100214

### SUMMARY

### Technical Problem

Meanwhile, there is a need to appropriately control a robot arm in accordance with a state of a target object in a robot system.

An objective of an example aspect of the present disclosure is to provide a control device, a robot system, a control method, and a recording medium capable of satisfying the above need.

### Solution to Problem

In order to achieve the above-described objective, according to an example aspect of the present disclosure, there is provided a control device including: a constraint means configured to set a condition for a face of a target object, which is included in constraint conditions for deciding a posture of the target object and a movement path of the target object and related to a grasp of the target object, release of the grasp of the target object, or a switching of the target object from one robot arm to another robot arm, according to an expression using a direction in which the target object is grasped and a direction in which the posture of the target object is defined; and a control means configured to control at least one of a first grasping mechanism and a second grasping mechanism so that the target object is grasped, the grasp of the target object is released, or the target object is switched from one robot arm to another robot arm using the face decided based on the condition set by the constraint means.

In order to achieve the above-described objective, according to another example aspect of the present disclosure, there is provided a robot system including: a first grasping mechanism; a second grasping mechanism; and the above-described control device.

In order to achieve the above-described objective, according to yet another example aspect of the present disclosure, there is provided a control method including: setting a condition for a face of a target object, which is included in constraint conditions for deciding a posture of the target object and a movement path of the target object and related to a grasp of the target object, release of the grasp of the target object, or a switching of the target object from one robot arm to another robot arm, according to an expression using a direction in which the target object is grasped and a direction in which the posture of the target object is defined; and controlling at least one of a first grasping mechanism and a second grasping mechanism so that the target object is grasped, the grasp of the target object is released, or the target object is switched from one robot arm to another robot arm using the face decided based on the set condition.

In order to achieve the above-described objective, according to yet another example aspect of the present disclosure, there is provided a recording medium storing a program for causing a computer to: set a condition for a face of a target object, which is included in constraint conditions for deciding a posture of the target object and a movement path of the target object and related to a grasp of the target object, release of the grasp of the target object, or a switching of the target object from one robot arm to another robot arm, according to an expression using a direction in which the target object is grasped and a direction in which the posture of the target object is defined; and control at least one of a first grasping mechanism and a second grasping mechanism so that the target object is grasped, the grasp of the target object is released, or the target object is switched from one robot arm to another robot arm using the face decided based on the set condition.

In order to achieve the above-described objective, according to yet another example aspect of the present disclosure, there is provided a control device including: a decision means configured to decide a direction in which a second grasping mechanism grasps a target object based on a direction of a face of the target object grasped by a first grasping mechanism; and a control means configured to control an operation of the second grasping mechanism so that the target object is grasped in the direction decided by the decision means.

In order to achieve the above-described objective, according to yet another example aspect of the present disclosure, there is provided a control device including: a decision means configured to decide an operation in which a first grasping mechanism and a second grasping mechanism grasp a target object based on a grasping direction of the first grasping mechanism, a grasping direction of the second grasping mechanism, and a direction of a face of the target object; and a control means configured to perform a control process so that the first grasping mechanism and the second grasping mechanism perform the decided operation.

### Advantageous Effects of Invention

According to the example aspects of the present disclosure, it is possible to appropriately control a robot arm in accordance with a state of a target object in a robot system.

### BRIEF DESCRIPTION OF DRAWINGS

FIG. 1 is a diagram showing an example of a configuration of a robot system according to an example embodiment of the present disclosure.

FIG. 2 is a diagram showing an example of a configuration of a control device according to the example embodiment of the present disclosure.

FIG. 3 is a diagram showing an example of a configuration of a generation unit according to the example embodiment of the present disclosure.

FIG. 4 is a diagram showing an example of position coordinates and axis vectors of a robot hand in the example embodiment of the present disclosure.

FIG. 5 is a diagram showing an example of the position coordinates and axis vectors of a target object in an example embodiment of the present disclosure.

FIG. 6 is a first diagram for describing constraint conditions in the example embodiment of the present disclosure.

FIG. 7 is a second diagram for describing constraint conditions in the example embodiment of the present disclosure.

FIG. 8 is a third diagram for describing constraint conditions in the example embodiment of the present disclosure.

FIG. 9 is a fourth diagram for describing constraint conditions in the example embodiment of the present disclosure.

FIG. 10 is a fifth diagram for describing constraint conditions in the example embodiment of the present disclosure.

FIG. 11 is a diagram showing an example of steps and a movement path of a target object in the example embodiment of the present disclosure.

FIG. 12 is a diagram showing an image of a solution obtained using Lagrange's undetermined multiplier method.

FIG. 13 is a first diagram for describing a method of efficiently obtaining a desired solution in the example embodiment of the present disclosure.

FIG. 14 is a second diagram for describing a method of efficiently obtaining a desired solution in the example embodiment of the present disclosure.

FIG. 15 is a diagram showing an example of an initial plan sequence generated by the generation unit according to the example embodiment of the present disclosure.

FIG. 16 is a diagram showing an example of an initial plan control signal generated by a control unit according to a first example embodiment of the present disclosure.

FIG. 17 is a diagram showing an example of a processing flow of a robot system according to the example embodiment of the present disclosure.

FIG. 18 is a diagram showing an example of a configuration of a robot according to another example embodiment of the present disclosure.

FIG. 19 is a diagram showing an example of a configuration of a control device having a minimum configuration according to the example embodiment of the present disclosure.

FIG. 20 is a diagram showing an example of a processing flow of the control device having the minimum configuration according to the example embodiment of the present disclosure.

FIG. 21 is a schematic block diagram showing a computer configuration according to at least one example embodiment.

### EXAMPLE EMBODIMENT

Hereinafter, example embodiments will be described in detail with reference to the drawings.

### Example Embodiment

A robot system 1 according to an example embodiment of the present disclosure is a system for moving a target object M located at one position to another position. For example, the robot system 1 obtains a posture and a path in the movement of the target object M within a range that satisfies constraint conditions to be described below. The robot system 1 generates a control signal for moving the target object M in a desired posture and path. Also, the robot system 1 controls a robot arm that grasps the target object M using the generated control signal. By executing these processes, the robot system 1 moves the target object M located at one position to another position. Hereinafter, the robot system 1 will be described.

### (Configuration of Robot System)

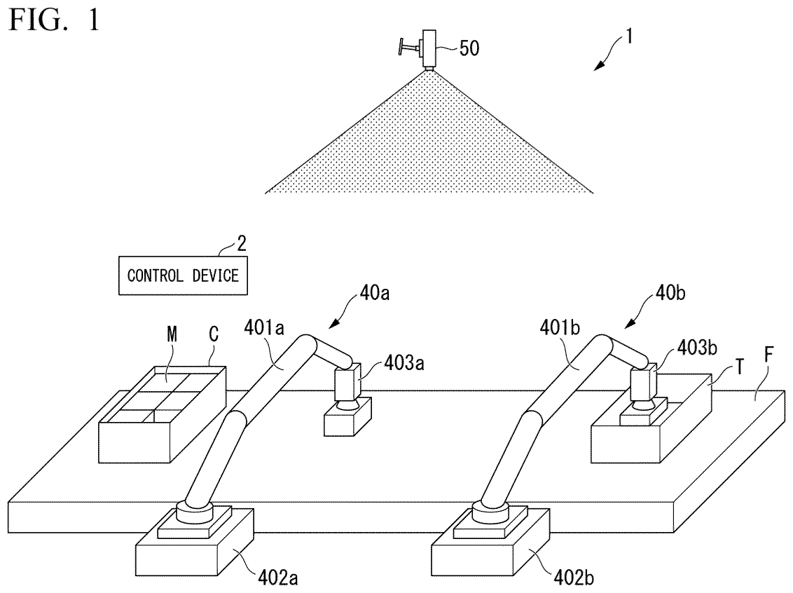

FIG. 1 is a diagram showing an example of a configuration of the robot system 1 according to the example embodiment of the present disclosure. As shown in FIG. 1, the robot system 1 includes a control device 2, robots 40a and 40b, and an image device 50.

As shown in FIG. 1, the robot 40a includes a robot arm 401a, a pedestal 402a, and a robot hand 403a (an example of a first grasping mechanism). The robot arm 401a is connected to the pedestal 402a. The robot hand 403a is connected to an end on an opposite side of an end where the robot arm 401a is connected to the pedestal 402a. The robot hand 403a includes, for example, two or more pseudo-fingers or vacuums resembling the fingers of a human, animal, or the like. The robot hand 403a grasps the target object M in accordance with a control signal output by the control device 2. The robot arm 401a moves the target object M from a movement source to a movement destination in accordance with the control signal output by the control device 2.

Moreover, as shown in FIG. 1, the robot 40b includes a robot arm 401b, a pedestal 402b, and a robot hand 403b (an example of a second grasping mechanism). The robot arm 401b is connected to the pedestal 402b. The robot hand 403b is connected to an end on an opposite side of an end where the robot arm 401b is connected to the pedestal 402b. The robot hand 403b includes, for example, two or more pseudo-fingers or vacuums resembling the fingers of a human, animal, or the like. The robot hand 403b grasps the target object M in accordance with a control signal output by the control device 2. The robot arm 401b moves the target object M from a movement source to a movement destination in accordance with the control signal output by the control device 2.

In addition, in each example embodiment of the present disclosure, a “grasp” includes “adsorption” in which the target object M is suctioned by a vacuum or the like and a “pinch” in which a physical object is pinched by two or more pseudo-fingers resembling fingers of a human, animal. Hereinafter, the robots 40a and 40b are collectively referred to as robots 40. Moreover, the robot arms 401a and 401b are collectively referred to as robot arms 401. Moreover, the pedestals 402a and 402b are collectively referred to as pedestals 402. Moreover, the robot hands 403a and 403b are collectively referred to as robot hands 403.

The image device 50 captures a state of the target object M. The image device 50 is, for example, a depth camera, which can identify the state of the target object M (i.e., a position and posture thereof). The image captured by the image device 50 is indicated by, for example, colored point cloud data, and includes three-dimensional information of a captured physical object. The image device 50 outputs a captured image to the generation unit 202.

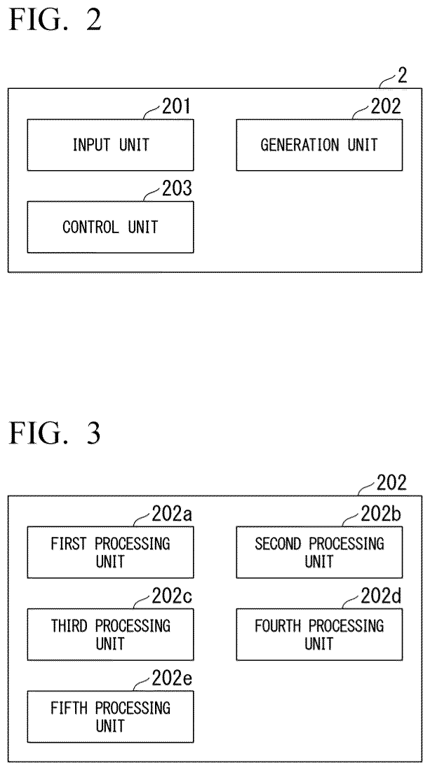

FIG. 2 is a diagram showing an example of a configuration of the control device 2 according to the example embodiment of the present disclosure. As shown in FIG. 2, the control device 2 includes an input unit 201, a generation unit 202, and a control unit 203.

The input unit 201 inputs a task goal and constraint conditions to the generation unit 202. Examples of the task goal include information indicating a type of target object M, the number of target objects M to be moved, a movement source of the target object M, and a movement destination of the target object M, and the like. Examples of the constraint conditions include an entry prohibition area in a case where the target object M is moved, an area that deviates a movable range of the robot 40, a condition for a face of the target object M related to a grasp of the target object M, release of the grasp of the target object M, or a switching of the target object M from one robot arm to another robot arm, and the like. As a task goal, the input unit 201 may receive, for example, an input “Move three products A from a cardboard box C to a tray T,” from a user, identify that the type of target object M to be moved is products A, the number of target objects M to be moved is three, the movement source of the target object M is the cardboard box C, and the movement destination of the target object M is the tray T, and may input identified information to the generation unit 202. Moreover, the position of the target object M identified in the image captured by the image device 50 may be designated as the movement source of the target object M. Moreover, the input unit 201, for example, may receive a position of an obstacle during movement of the target object M from the movement source to the movement destination from the user as a constraint condition indicating the entry prohibition area and input the information thereof to the generation unit 202. Moreover, a file indicating a constraint condition is stored in a storage device and the input unit 201 may input the constraint condition indicated in the file to the generation unit 202 and/or the fourth processing unit 202d of the generation unit 202 to be described below may read the constraint condition directly from the file. That is, the acquisition method may be of any type as long as the generation unit 202 can acquire the necessary task goal and the necessary constraint conditions. Details of a method of defining the constraint conditions will be described below.

FIG. 3 is a diagram showing an example of a configuration of the generation unit 202 according to the example embodiment of the present disclosure. As shown in FIG. 3, the generation unit 202 includes a first processing unit 202a, a second processing unit 202b, a third processing unit 202c, a fourth processing unit 202d (an example of a constraint means), and a fifth processing unit 202e (an example of a control means).

The first processing unit 202a recognizes the robot 40. For example, the first processing unit 202a recognizes a robot model using computer-aided design (CAD) data. The CAD data includes information indicating the shape of the robot 40 and information indicating a movable range such as a reach range of the robot arm 401. The shape includes dimensions. The CAD data is, for example, drawing data designed in CAD.

Moreover, the first processing unit 202a recognizes a surrounding environment of the robot 40. For example, the first processing unit 202a acquires an image captured by the image device 50. The image captured by the image device 50 includes information captured by the camera and information in a depth direction. This depth direction information corresponds to the colored point cloud data described above. The first processing unit 202a recognizes a position and shape of an obstacle from the image that has been acquired. The obstacle here includes all physical objects other than the target object M to be moved to the movement destination by the robot 40 located within the capturing range of the image device 50. As described above, the image device 50 can acquire three-dimensional information of a physical object within the imaging range. Therefore, the first processing unit 202a can recognize a surrounding environment of the robot 40 including the position and shape of the obstacle. In addition, the first processing unit 202a is not limited to a processing unit that recognizes the surrounding environment of the robot 40 from the image captured by the image device 50. For example, the first processing unit 202a may recognize the surrounding environment of the robot 40 using a three-dimensional occupancy map (Octomap), CAD data, augmented reality (AR) markers, and the like. This CAD data includes information indicating the shape of the obstacle. The shape includes dimensions.

Moreover, the first processing unit 202a recognizes a release position at the movement destination of the target object M. For example, in a case where the movement destination is a container (for example, the tray T), the first processing unit 202a recognizes the release position with machine learning using model-based matching. The model-based matching is one of methods of deciding a position and posture of a physical object by performing a comparison with a shape and structure data for the physical object extracted from the image using image data obtained from the camera or the like and a shape and structure data of a physical object (a container in this case) whose position or posture is desired to be acquired. In addition, the first processing unit 202a is not limited to a process of recognizing the release position by performing machine learning using model-based matching. For example, the first processing unit 202a may recognize the release position using an AR marker.

Moreover, the second processing unit 202b recognizes the pedestal 402 of the robot 40 to be described below. For example, the second processing unit 202b recognizes the pedestal 402 by acquiring CAD data. This CAD data includes information indicating the shape of the pedestal 402. The shape includes dimensions. Thereby, the second processing unit 202b can recognize a Z-coordinate of an upper face of the pedestal 402 in a coordinate system as a height of the pedestal 402.

The third processing unit 202c recognizes a state of the target object M (i.e., a position and posture thereof). For example, the third processing unit 202c recognizes the position of the target object M by performing machine learning using model-based matching. Moreover, the third processing unit 202c recognizes the posture of the target object M using technology for generating a bounding box such as an axis aligned bounding box (AABB) or an oriented bounding box (OBB) for the target object M whose position is identified. In addition, the third processing unit 202c may classify the target object M using clustering, which is one of the machine learning methods, and the like with respect to the image captured by the image device 50 and may identify a state of the target object M using technology for generating a bounding box.

Moreover, the third processing unit 202c acquires a height of the target object M. For example, the third processing unit 202c recognizes the target object M by acquiring CAD data. This CAD data includes information indicating the shape of the target object M. The shape includes dimensions. Thereby, the third processing unit 202c can recognize a Z-coordinate of the target object M in a coordinate system as a height of the target object M. In addition, the third processing unit 202c may recognize the height of the target object M by subtracting the Z-coordinate of the pedestal 402 from a Z-coordinate of an upper face of the target object M.

The fourth processing unit 202d acquires constraint conditions. Also, the fourth processing unit 202d sets the acquired constraint conditions. Here, details of a method of defining constraint conditions will be described. Here, types of constraint conditions for a face of the target object M related to a grasp of the target object M, release of the grasp of the target object M, or a switching of the target object M from one robot arm to another robot arm in the robot 40 will be described.

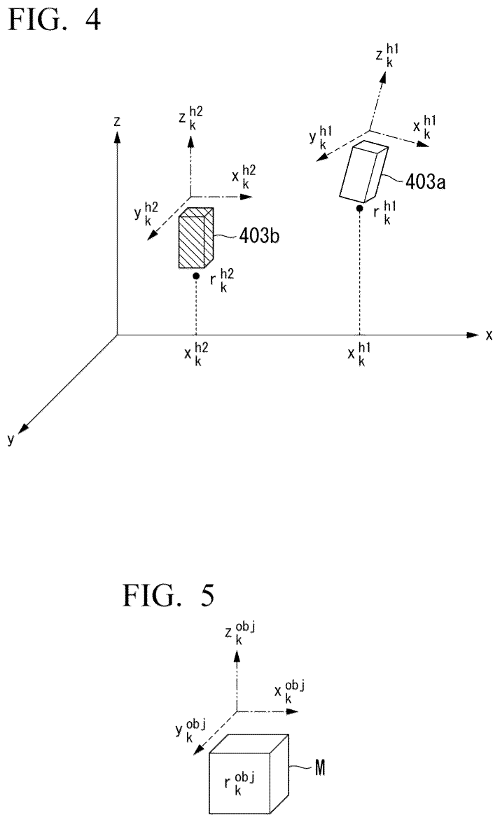

FIG. 4 is a diagram showing an example of position coordinates and axis vectors of the robot hands 403 in the example embodiment of the present disclosure. First, the position coordinates and axis vectors of the robot hands 403 at time k are defined using notations in FIG. 4. That is, it is assumed that position coordinates r(h1, k) of the robot hand 403a at time k are expressed as shown in Expression (1). Moreover, it is assumed that the position coordinates r(h2, k) of the robot hand 403b at time k are expressed as shown in Expression (2). In addition, the position coordinates r(h1, k) and the position coordinates r(h2, k) indicate positions of the robot hand 403a and the robot hand 403b at time k in a three-dimensional space R3 in which the robot 40 including the robot hand 403a and the robot hand 403b operates and the target object M moves (e.g., a three-dimensional space R3 expressed by three axes. i.e. an x-axis, a y-axis, and a z-axis, in FIG. 4). Moreover, it is assumed that an x-axis vector x(h1, k) of the robot hand 403a at time k is expressed as shown in Expression (3), a y-axis vector y(h1, k) is expressed as shown in Expression (4), and a z-axis vector z(h1, k) is expressed as shown in Expression (5). Moreover, it is assumed that the x-axis vector x(h2, k) of the robot hand 403b at time k is expressed as shown in Expression (6), the y-axis vector y(h2, k) of the robot hand 403b at time k is expressed as shown in Expression (7), and the z-axis vector z(h2, k) of the robot hand 403b at time k is expressed as shown in Expression (8). In addition, for the three-dimensional shape of each of the robot hand 403a and the robot hand 403b, the x-axis, the y-axis, and the z-axis are unambiguously determined independently of the three-dimensional space R3. The x-axis vector x(h1, k) indicates a direction of the x-axis at time k in the three-dimensional space R3 set for the three-dimensional shape of the robot hand 403a. The y-axis vector y(h1, k) indicates a direction of the y-axis at time k in the three-dimensional space R3 set for the three-dimensional shape of the robot hand 403a. The z-axis vector z(h1, k) indicates a direction of the z-axis at time k in the three-dimensional space R3 set for the three-dimensional shape of the robot hand 403a. Moreover, the x-axis vector x(h2, k) indicates a direction of the x-axis at time k in the three-dimensional space R3 set for the three-dimensional shape of the robot hand 403b. The y-axis vector y(h2, k) indicates a direction of the y-axis at time k in the three-dimensional space R3 set for the three-dimensional shape of the robot hand 403b. The z-axis vector z(h2, k) indicates a direction of the z-axis at time k in the three-dimensional space R3 set for the three-dimensional shape of the robot hand 403b.

$$\begin{matrix}[ Math . 1 ] & \\ r ( h 1 , k ) = {r}_{k}^{h 1} & ( 1 )\end{matrix}$$

$$\begin{matrix}[ Math . 2 ] & \\ r ( h 2 , k ) = {r}_{k}^{h 2} & ( 2 )\end{matrix}$$

$$\begin{matrix}[ Math . 3 ] & \\ x ( h 1 , k ) = {x}_{k}^{h 1} & ( 3 )\end{matrix}$$

$$\begin{matrix}[ Math . 4 ] & \\ y ( h 1 , k ) = {y}_{k}^{h 1} & ( 4 )\end{matrix}$$

$$\begin{matrix}[ Math . 5 ] & \\ z ( h 1 , k ) = {z}_{k}^{h 1} & ( 5 )\end{matrix}$$

$$\begin{matrix}[ Math . 6 ] & \\ x ( h 2 , k ) = {x}_{k}^{h 2} & ( 6 )\end{matrix}$$

$$\begin{matrix}[ Math . 7 ] & \\ y ( h 2 , k ) = {y}_{k}^{h 2} & ( 7 )\end{matrix}$$

$$\begin{matrix}[ Math . 8 ] & \\ z ( h 2 , k ) = {z}_{k}^{h 2} & ( 8 )\end{matrix}$$

Each of the axis vectors represented by Expressions (3) to (8) is a unit vector. Here, for convenience, the unit vector is used, but the axis vector may not necessarily be the unit vector, and a length of the vector may vary with a direction of the axis vector.

Moreover, it is assumed that the three-dimensional space R3 of the x-axis, y-axis, and z-axis shown in FIG. 4 is expressed as shown in Expression (9).

$$\begin{matrix}[ Math . 9 ] & \\ R 3 = {ℝ}^{3} & ( 9 )\end{matrix}$$

In this case, Expression (10) holds for the position coordinates of the robot hands 403. Moreover, Expression (11) holds for the axis vectors of the robot hands 403.

$$\begin{matrix}[ Math . 10 ] & \\ {r}_{k}^{h 1} , {r}_{k}^{h 2} ∈ {ℝ}^{3} & ( 10 )\end{matrix}$$

$$\begin{matrix}[ Math . 11 ] & \\ {x}_{k}^{h 1} , {x}_{k}^{h 2} , {y}_{k}^{h 1} , {y}_{k}^{h 2} , {z}_{k}^{h 1} , {z}_{k}^{h 2} ∈ {ℝ}^{3} & ( 11 )\end{matrix}$$

That is, the position coordinates of each of robot hands 403 at time k are an element of a three-dimensional space. Moreover, the axis vector of each of robot hands 403 at time k is an element of a three-dimensional space.

In this case, the position coordinates of the robot hand 403a can be defined as shown in Expression (12). Moreover, the position coordinates of the robot hand 403b can be defined as shown in Expression (13). In addition, in Expressions (12) and (13), T denotes a transpose operation.

$$\begin{matrix}[ Math . 12 ] & \\ {r}_{k}^{h 1} := {( {x}_{k}^{h 1} , {y}_{k}^{h 1} , {z}_{k}^{h 1} )}^{T} & ( 12 )\end{matrix}$$

$$\begin{matrix}[ Math . 13 ] & \\ {r}_{k}^{h 2} := {( {x}_{k}^{h 2} , {y}_{k}^{h 2} , {z}_{k}^{h 2} )}^{T} & ( 13 )\end{matrix}$$

FIG. 5 is a diagram showing an example of the position coordinates and axis vectors of the target object M in the example embodiment of the present disclosure. Here, the position coordinates and the axis vectors of the target object M at time k are defined using the notation in FIG. 5. That is, it is assumed that the position coordinates r(obj, k) of the target object M at time k are expressed as shown in Expression (14). Moreover, it is assumed that the x-axis vector x(obj, k) of the target object M at time k is expressed as shown in Expression (15), the y-axis vector y(obj, k) of the target object M at time k is expressed as shown in Expression (16), and the z-axis vector z(obj, k) of the target object M at time k is expressed as shown in Expression (17). In addition, the position coordinates r(obj, k) indicates the position of the target object M at time k in the three-dimensional space R3 (e.g., the three-dimensional space R3 represented by the three axes of the x-axis, the y-axis, and the z-axis in FIG. 4). Moreover, the x-axis, the y-axis, and the z-axis are set wherein the x-axis, the y-axis, and the z-axis are unambiguously determined independently of the three-dimensional space R3 for the three-dimensional shape in the target object M, as in the robot hand 403a and the robot hand 403b. The x-axis vector x(obj, k) indicates a direction of the x-axis at time k in the three-dimensional space R3 set for the three-dimensional shape of the target object M. The y-axis vector y(obj, k) indicates a direction of the y-axis at time k in the three-dimensional space R3 set for the three-dimensional shape of the target object M. The z-axis vector z(obj, k) indicates a direction of the z-axis at time k in the three-dimensional space R3 set for the three-dimensional shape of the target object M.

$$\begin{matrix}[ Math . 14 ] & \\ r ( obj , k ) = {r}_{k}^{obj} & ( 14 )\end{matrix}$$

$$\begin{matrix}[ Math . 15 ] & \\ x ( obj , k ) = {x}_{k}^{obj} & ( 15 )\end{matrix}$$

$$\begin{matrix}[ Math . 16 ] & \\ y ( obj , k ) = {y}_{k}^{obj} & ( 16 )\end{matrix}$$

$$\begin{matrix}[ Math . 17 ] & \\ z ( obj , k ) = {z}_{k}^{obj} & ( 17 )\end{matrix}$$

That is, the position coordinates of the target object M at time k are an element of a three-dimensional space. Moreover, the axis vector of the target object M at time k is an element of a three-dimensional space.

(In Case of Robot Hand that Adsorbs Target Object)

First, how a face of the target object M is expressed as constraint conditions will be described, wherein the face of the target object M is related to a grasp of the target object M, release of the grasp of the target object M, or a switching of the target object M from one robot arm to another robot arm with respect to the robot hands 403 for adsorbing the target object M.

(In a Case where Target Object is Grasped or Released)

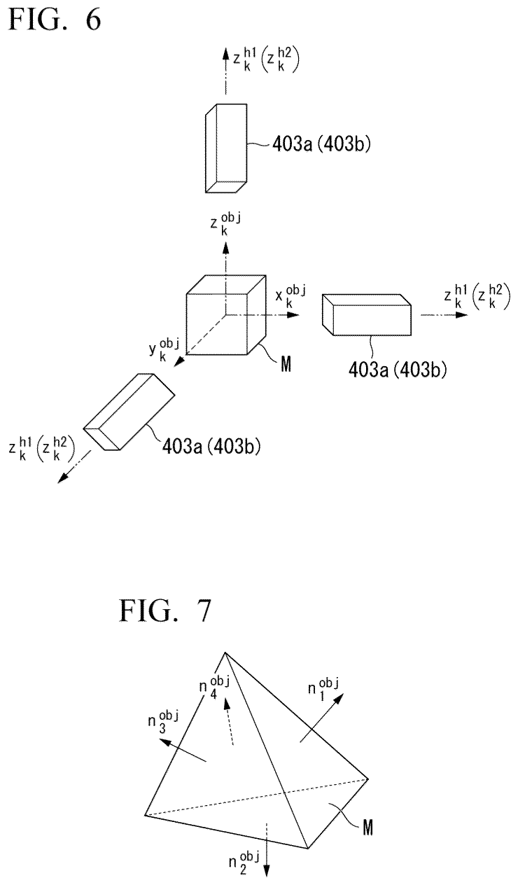

FIG. 6 is a first diagram for describing constraint conditions in the example embodiment of the present disclosure. FIG. 6 is a diagram for describing constraint conditions in a case where the position coordinates and axis vectors of the robot hands 403, and the position coordinates and the axis vector of the target object M are defined as shown in Expressions (1) to (17) described above. As can be seen from FIG. 6, in a case where the target object M is grasped or in a case where the grasp of the target object M is released, a direction perpendicular to an adsorption face of the target object M needs to coincide with a suction direction of the robot hand 403. A vector indicating the suction direction is an example of a first vector. That is, in a case where the target object M is grasped or in a case where the grasp of the target object M is released, the constraint conditions for the robot hand 403a can be described according to a product of norms of outer products using outer products that are a calculation operation for an angle formed by a first vector indicating a direction in which the target object M is grasped and a second vector indicating an axis for defining the posture of the target object M as shown in Expression (18). Moreover, in a case where the target object M is grasped or in a case where the grasp of the target object M is released, the constraint conditions for the robot hand 403b can be described according to a product of norms of outer products using outer products as shown in Expression (19).

$$\begin{matrix}[ Math . 18 ] & \\ ‖ {z}_{k}^{h 1} \times {z}_{k}^{obj} ‖ \cdot ‖ {z}_{k}^{h 1} \times {y}_{k}^{obj} ‖ \cdot ‖ {z}_{k}^{h 1} \times {x}_{k}^{obj} ‖ = 0 & ( 18 )\end{matrix}$$

$$\begin{matrix}[ Math . 19 ] & \\ ‖ {z}_{k}^{h 2} \times {z}_{k}^{obj} ‖ \cdot ‖ {z}_{k}^{h 2} \times {y}_{k}^{obj} ‖ \cdot ‖ {z}_{k}^{h 2} \times {x}_{k}^{obj} ‖ = 0 & ( 19 )\end{matrix}$$

In addition, Expressions (18) and (19) are constraint conditions under the assumption that the target object M has a shape as shown in FIG. 6 in which a hexahedron, e.g., a cube or a cuboid, has two faces parallel to a direction of each of the x-axis, the y-axis, and the z-axis. For example, in the case of a tetrahedron, the description of the constraint conditions differs from Expressions (18) and (19).

FIG. 7 is a second diagram for describing constraint conditions in the example embodiment of the present disclosure. In FIG. 7, a normal line of each face of a tetrahedron is shown. In a case where a target object M having this tetrahedral shape is grasped or in a case where the grasp of the target object M is released, the constraint conditions for the robot hand 403a under a concept similar to the hexahedron shown in FIG. 6 (i.e., under the concept that a direction perpendicular to the adsorption face of the target object M needs to coincide with a suction direction of the robot hand 403) can be described according to a product of norms of outer products using outer products as shown in Expression (20). Moreover, in a case where the target object M is grasped or in a case where the grasp of the target object M is released, the constraint conditions for the robot hand 403b can be described according to a product of norms of outer products using outer products as shown in Expression (21).

$$\begin{matrix}[ Math . 20 ] & \\ ‖ {z}_{k}^{h 1} \times {n}_{1}^{obj} ‖ \cdot ‖ {z}_{k}^{h 1} \times {n}_{2}^{obj} ‖ \cdot ‖ {z}_{k}^{h 1} \times {n}_{3}^{obj} ‖ \cdot ‖ {z}_{k}^{h 1} \times {n}_{4}^{obj} ‖ = 0 & ( 20 )\end{matrix}$$

$$\begin{matrix}[ Math . 21 ] & \\ ‖ {z}_{k}^{h 2} \times {n}_{1}^{obj} ‖ \cdot ‖ {z}_{k}^{h 2} \times {n}_{2}^{obj} ‖ \cdot ‖ {z}_{k}^{h 2} \times {n}_{3}^{obj} ‖ \cdot ‖ {z}_{k}^{h 2} \times {n}_{4}^{obj} ‖ = 0 & ( 21 )\end{matrix}$$

However, there are no faces parallel to each other in the case of this tetrahedron. Therefore, the robot hand 403 cannot grasp the target object M unless the robot hand 403 approaches the face of the target object M to be grasped in a correct direction. A constraint condition expressed by a product of norms of outer products using the outer products as shown in Expressions (20) and (21) indicates a scalar quantity. Therefore, the constraint condition requires that any one of the normal lines of faces is parallel to the suction direction of the robot hand 403, but does not require that a direction of any one of the normal lines of faces coincides with the suction direction of the robot hand 403. Therefore, in order to require that a direction of any one of the normal lines of faces coincides with the suction direction of the robot hand 403 according to the constraint condition, it is necessary to add a new constraint condition indicating a normal direction of a face consistent with the suction direction of the robot hand 403. This example is a constraint condition added by Expression (22) to the robot hand 403a and a constraint condition added by Expression (23) to the robot hand 403b.

$$\begin{matrix}[ Math . 22 ] & \\ {\prod }_{i = 1 , 2 , 3 , 4} {( 1 - {z}_{k}^{h 1} \cdot {n}_{i}^{obj} )}^{2} = 0 & ( 22 )\end{matrix}$$

$$\begin{matrix}[ Math . 23 ] & \\ {\prod }_{i = 1 , 2 , 3 , 4} {( 1 - {z}_{k}^{h 2} \cdot {n}_{i}^{obj} )}^{2} = 0 & ( 23 )\end{matrix}$$

The constraint conditions represented by Expressions (22) and (23) require that a magnitude of an inner product, which is a calculation operation for an angle formed by a vector indicated by a normal line of each face and a vector indicating a suction direction of the robot hand 403, is 1, i.e., that the directions of the vectors coincide with each other. Therefore, for a target object M having a shape in which there are no parallel faces such as a tetrahedron, it is possible to cause the robot hand 403 to grasp the target object M by adding a constraint condition requiring that a magnitude of an inner product of a vector indicated by a normal line of each face and a vector indicating a suction direction of the robot hand 403 is 1 as shown in Expressions (22) and (23).

In addition, in a case where there are two faces parallel to a direction of each of the x-axis, the y-axis, and the z-axis as in a hexahedron such as a cube or a cuboid, because the norms of the outer products overlap, an expression indicating a calculation operation for a norm of one outer product for each of the x-axis direction, the y-axis direction, and the z-axis direction is given as shown in Expressions (18) and (19). However, as shown in Expressions (22) and (23), an expression for calculating the inner product for each face is given. That is, for each face of the target object M, as shown in Expressions (22) and (23), it is possible to define an expression indicating a constraint condition for a target object M of arbitrary shape using a calculation operation based on an angle formed by two directions, i.e., an expression for calculating an inner product. In addition, the constraint conditions based on an expression for calculating the inner product for each face include a constraint condition based on an expression for calculating the outer product. Therefore, as shown in Expressions (22) and (23), in a case where an expression is used to calculate an inner product for each face, constraint conditions due to an expression for calculating an outer product are unnecessary. However, a new constraint condition indicating a normal direction of a face consistent with the suction direction of the robot hand 403 is not limited to the inner product. If the constraint condition due to the expression for calculating the outer product is used, it is only necessary to newly add a constraint condition indicating a normal direction of a face consistent with the suction direction of the robot hand 403.

(In a Case where Target Object is Switched from One Robot Arm to Another Robot Arm)

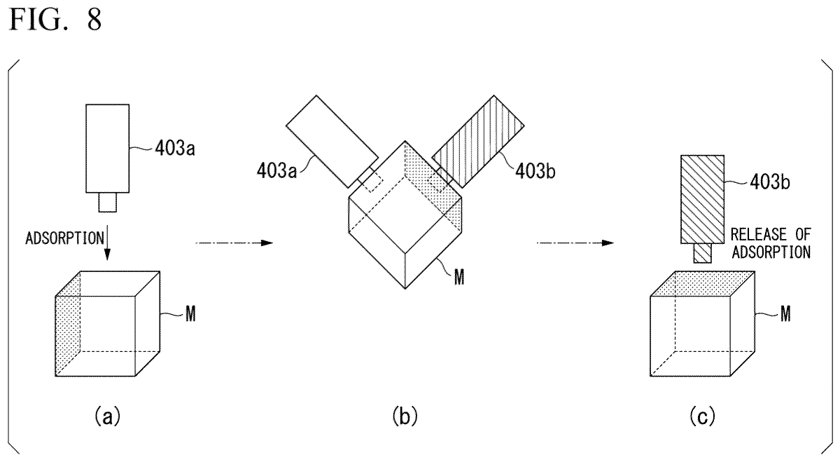

FIG. 8 is a third diagram for describing constraint conditions in the example embodiment of the present disclosure. FIG. 8 is an image diagram of processes performed by the robot hand 403a and the robot hand 403b. A part (a) of FIG. 8 shows a process in which the robot hand 403a grasps the target object M. A part (b) of FIG. 8 shows a process of switching the target object M from the robot hand 403a to the robot hand 403b (i.e., handing over the target object M). Apart (c) of FIG. 8 shows a process in which the robot hand 403b releases the grasp of the target object M. Description of the constraint conditions in the process shown in the parts (a) and (c) of FIG. 8 is as described above. Here, a constraint condition in a process shown in the part (b) of FIG. 8 (i.e., a process of switching the target object M from one robot arm to another robot arm) will be described.

In a case where the target object M is switched from the robot hand 403a to the robot hand 403b, each of the robot hands 403 needs to satisfy the constraint conditions in the case of the grasp of the target object M or the release of the grasp of the target object M. Therefore, as shown in FIG. 8, the constraint condition in a case where the target object M is a hexahedron such as a cube or a cuboid becomes a constraint condition in which Expressions (18) and (19) are required at the same time. In addition, the constraint condition in a case where the target object M does not have parallel faces as in a tetrahedron is a constraint condition in which Expressions (20) to (23) are required at the same time.

(Case of Robot Hands of Type in which Target Object is Pinched)

Next, how a face of the target object M is expressed as constraint conditions will be described, wherein the face of the target object M is related to a grasp of the target object M, release of the grasp of the target object M, or a switching of the target object M from one robot arm to another robot arm with respect to the robot hands 403 for pinching the target object M.

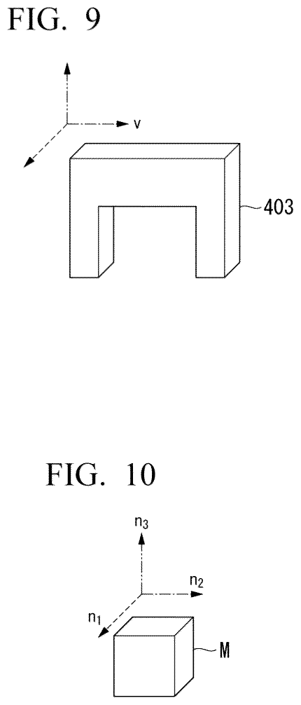

FIG. 9 is a fourth diagram for describing constraint conditions in the example embodiment of the present disclosure. A direction of v in FIG. 9 coincides with a direction in which the robot hand 403 pinches the target object M. FIG. 10 is a fifth diagram for describing constraint conditions in the example embodiment of the present disclosure. In FIG. 10, n₁, n₂, and n₃ correspond to a y-axis vector, an x-axis vector, and a z-axis vector shown in FIG. 5. In the case of the robot hand 403 of the type in which the target object M is pinched, it is only necessary to consider constraint conditions similar to the constraint conditions for the robot hand 403 of the type in which the target object M is adsorbed by causing a direction in which the target object M is pinched, i.e., a direction of v in FIG. 9, to coincide with the suction direction of the robot hand 403 of the type in which the target object M is adsorbed.

(In a Case where Target Object is Grasped or in a Case where Grasp of Target Object is Released)

The constraint conditions for the robot hand 403 shown in FIG. 9 and the target object M shown in FIG. 10 in a case where the target object M is grasped or in a case where the grasp of the target object M is released can be expressed as shown in Expression (24) for each of the robot hands 403 by causing the suction direction of the robot hand 403 of a type in which the target object M is adsorbed to coincide with the direction in which the target object M is pinched.

$$\begin{matrix}[ Math . 24 ] & \\ {\prod }_{i = 1}^{3} {‖ v \times {n}_{i} ‖}^{2} = 0 & ( 24 )\end{matrix}$$

Moreover, the constraint conditions for the robot hand 403 shown in FIG. 9 and the target object M shown in FIG. 10 in a case where the target object M is switched from one robot arm to another robot arm require that Expression (24) is satisfied simultaneously for each of the robot hands 403.

The fourth processing unit 202d sets various constraint conditions including the constraint conditions as described above.

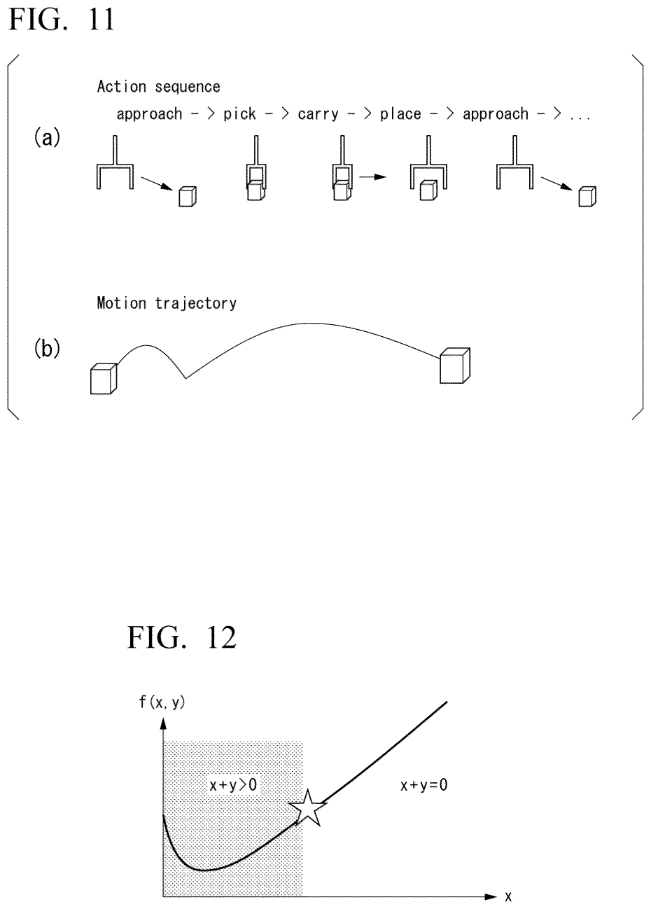

The fifth processing unit 202e generates an initial plan sequence indicating a flow of an operation of the robot 40 based on a task goal determined by processes of the first processing unit 202a, the second processing unit 202b, and the third processing unit 202c and constraint conditions set in a process of the fourth processing unit 202d. For example, the fifth processing unit 202e acquires the task goal from the first processing unit 202a, the second processing unit 202b, and the third processing unit 202c. Moreover, the fifth processing unit 202e acquires the constraint conditions from the fourth processing unit 202d. The fifth processing unit 202e adds the constraint conditions acquired from the fourth processing unit 202d to the constraint conditions input from the input unit 201. Also, the fifth processing unit 202e generates information indicating a state of the robot 40 for each time step during the process from a state of the target object M in a movement source to a state of the target object M in a movement destination necessary to generate a control signal for controlling the robot 40 in the control unit 203 based on the acquired task goal and constraint conditions (a type of the target object M, a position and posture of the robot 40, the strength of a grasp of the target object M, an operation of the robot 40 (e.g., an approach operation for moving toward the target object M (corresponding to the processing of an approach step in FIG. 11 to be described below), a pick operation for grasping the target object M (corresponding to the processing of a pick step in FIG. 11), a carry operation for moving an arm for correctly moving the grasped target object M to a transport destination (corresponding to the processing of a carry step in FIG. 11), or a place operation for releasing the grasp of the target object M (corresponding to the processing of a place step in FIG. 11)), or the like). That is, the information indicating the state of the robot 40 for each time step during the process from the state of the target object M in the movement source to the state of the target object M in the movement destination necessary to generate the control signal for controlling the robot 40 in the control unit 203 is a sequence.

FIG. 11 is a diagram showing an example of steps and a movement path of a target object M in the example embodiment of the present disclosure. The steps and the movement path of the target object M in the sequence for moving the target object M shown in FIG. 11 are obtained by designating a process of reducing an amount of energy to be consumed by the robot 40 as much as possible, a process of shortening a trajectory along which the robot arm 401 moves as much as possible, a process of shortening a movement path of the target object M as much as possible, or the like as an objective function in a case where a task goal and various constraint conditions are set and performing simulation in the fifth processing unit 202e. As shown in FIG. 11, examples of the step of moving the target object M from the movement source to the movement destination include an approach step of moving the robot arms 401a and 401b toward the target object M, a pick step of grasping the target object M, a carry step of moving the target object M, a place step of releasing the grasp of the target object M, and the like.

Here, a method by which the fifth processing unit 202e decides a posture and movement path of the target object M for each time step according to simulation will be described. Here, for simplicity, a method of minimizing a trajectory along which the robot arm 401 moves will be described. In this case, variables (for example, x and y), which affect the trajectory of the robot arm 401, are defined and a process of minimizing a function f(x, y) indicating the trajectory along which the robot arm 401 moves is designated as an objective function. Moreover, for example, a constraint condition such like x+y=0 is set due to a constraint on a movable region of the robot arm 401. In this case, a Lagrangian function L is given as in Expression (25) using a positive value of k.

$$\begin{matrix}[ Math . 25 ] & \\ L = f ( x , y ) + {λ ( x + y )}^{2} & ( 25 )\end{matrix}$$

Then, the fifth processing unit 202e may obtain a solution by using Lagrange's undetermined multiplier method. FIG. 12 is a diagram showing an image of a solution obtained by using Lagrange's undetermined multiplier method. In this case, the fifth processing unit 202e repeatedly searches for a region that satisfies the constraint condition x+y=0 and that has a local minimum value by differentiating the Lagrangian function L, thereby identifying a desired solution (an example of an optimal solution) indicated by a star in FIG. 12 in which the objective function f(x, y) is a minimum. In addition, the Lagrangian function L indicated by Expression (25) is an example and may be any Lagrangian function generally used in continuous optimization. For example, in a case where an optimization algorithm based on a gradient method referred to as a principal-dual interior-point method is used, the Lagrangian function L becomes a function referred to as a barrier function that has a value of zero in the region where the constraint conditions are not violated and takes an infinite value as soon as it enters a region that violates the constraint conditions.

However, in a case where a solution is obtained using the derivative of a function under the certain constraint conditions as described above, there is a possibility that a problem generally called a “non-convex constraint” in which a searchable region for a solution is limited by the constraint condition and a local minimum value cannot be searched for may occur.

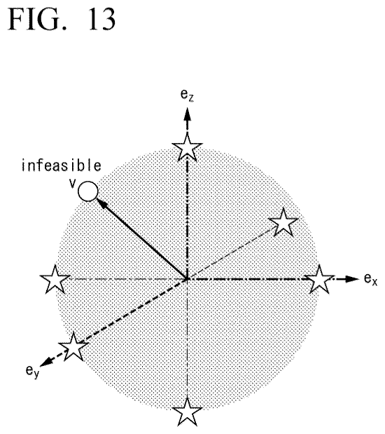

Here, a method of efficiently obtaining a desired solution even if a non-convex constraint problem occurs will be described. Here, the shape of the target object M is assumed to be a hexahedron having parallel faces such as a cube or a cuboid. Moreover, it is assumed that the robot hand 403 is of a type in which the target object M is pinched. In a case where the shape of the target object M is a hexahedron having parallel faces and the robot hand 403 is of a type in which the target object M is pinched, Expression (24) holds. FIG. 13 is a first diagram for describing a method of efficiently obtaining a desired solution in the example embodiment of the present disclosure. In Expression (24), a vector nᵢ indicating the suction direction of the robot hand 403 is indicated by vectors eₓ, e_{y}, and e_{z} in FIG. 13.

If a magnitude of the vector v is 1, there are only six feasible points indicated by stars among possible positions of the vector v in FIG. 13. That is, all but the six points indicated by the stars on the spherical surface in FIG. 13 are infeasible points. In this case, if the infeasible point is an initial search point, the fifth processing unit 202e cannot search for a point other than the initial search point. That is, the problem of non-convex constraint conditions occurs.

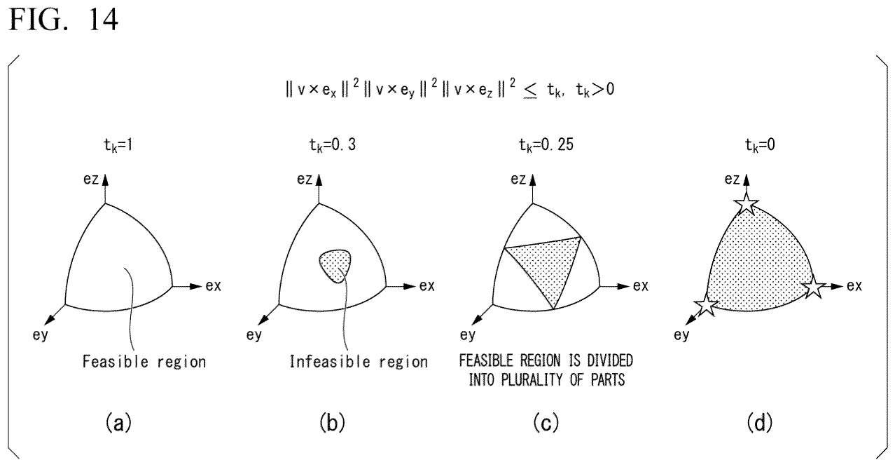

In such case, the fifth processing unit 202e uses, for example, a simulated annealing (SA) method. Specifically, the fifth processing unit 202e expands the search points by temporarily relaxing the constraint conditions and obtains a local minimum value (an example of a local optimal solution). FIG. 14 is a second diagram for describing a method of efficiently obtaining a desired solution in the example embodiment of the present disclosure. FIG. 14 shows only one-eighth of the spherical surface shown in FIG. 13. Moreover, each of the parts (a), (b), and (c) of FIG. 14 shows a difference in the infeasible region due to a difference in the degree of relaxation of the constraint condition using tₖ which is a positive value. Moreover, the part (d) of FIG. 14 indicates an infeasible region in the case of the original constraint condition (tₖ=0). In addition, in a case where the shape of the target object M is a hexahedron having parallel faces such as a cube or a cuboid, an infeasible region similar to the infeasible region shown in FIG. 14 also occurs in a portion other than one-eighth of the spherical surface shown in FIG. 14 due to the symmetry of the vector.

In the example of tₖ=1 shown in the part (a) of FIG. 14, all regions become feasible regions. Moreover, in the example of tₖ=0.3 shown in the part (b) of FIG. 14, a partial region becomes an infeasible region. Moreover, in the example of tₖ=0.25 shown in part (c) of FIG. 14, the feasible region is divided into a plurality of discontinuous regions due to the infeasible region. As shown in the part (c) of FIG. 14, in a case where the feasible region is divided into a plurality of discontinuous regions due to the infeasible region, the fifth processing unit 202e cannot search for another feasible region from a certain feasible region. That is, in a case where there is no desired solution in a certain feasible region, the fifth processing unit 202e cannot obtain a desired solution. Therefore, as shown in the part (c) of FIG. 14, in a case where the feasible region is divided into a plurality of discontinuous regions due to the infeasible region, the fifth processing unit 202e searches for a solution by adjusting a degree of relaxation of the constraint condition and changing a search condition such as randomly changing a search point without continuing a similar search. In addition, adjusting the degree of relaxation of the constraint condition and changing the search condition are examples of changing the content of the relaxation.

Therefore, even if a non-convex constraint problem occurs, as a method of efficiently obtaining the desired solution, the constraint condition in which the feasible region is divided into a plurality of discontinuous regions due to the infeasible region as shown in the part (c) of FIG. 14 (an example in which a local optimal solution is not obtained) is first obtained in advance according to simulation or the like. The fifth processing unit 202e stores the predetermined constraint conditions. Also, as shown in the part (a) of FIG. 14, the fifth processing unit 202e relaxes the constraint conditions so that all regions are feasible regions. In a state in which this constraint condition is relaxed, the fifth processing unit 202e obtains a local minimum value of the Lagrangian function L by differentiating the Lagrangian function L. Also, the fifth processing unit 202e confirms whether or not this local minimum value satisfies the original constraint condition. In a case where the original constraint condition is satisfied, the fifth processing unit 202e determines that the local minimum value is a desired solution. Moreover, in a case where the original constraint condition is not satisfied, the fifth processing unit 202e obtains the local minimum value of the Lagrangian function L by reducing the degree of relaxation of the constraint condition and differentiating the Lagrangian function L. Also, the fifth processing unit 202e confirms whether or not this local minimum value satisfies the original constraint condition. The fifth processing unit 202e iterates this process until a local minimum value satisfying the original constraint condition is obtained or until the constraint condition with a reduced degree of relaxation becomes a predetermined constraint condition (i.e., the feasible region is divided into a plurality of discontinuous regions due to the infeasible region). Moreover, in a case where the constraint condition whose degree of relaxation is reduced becomes a constraint condition in which the feasible region is divided into a plurality of discontinuous regions due to the infeasible region obtained in advance, the fifth processing unit 202e changes the search condition and searches for a solution by adjusting the degree of relaxation of the constraint condition. In this way, the control device 2 can efficiently obtain the desired solution even if a non-convex constraint problem occurs.

The fifth processing unit 202e outputs the generated sequence to the control unit 203. In addition, the fifth processing unit 202e may be implemented using artificial intelligence (AI) technology including temporal logic, reinforcement learning, optimization technology, and the like.

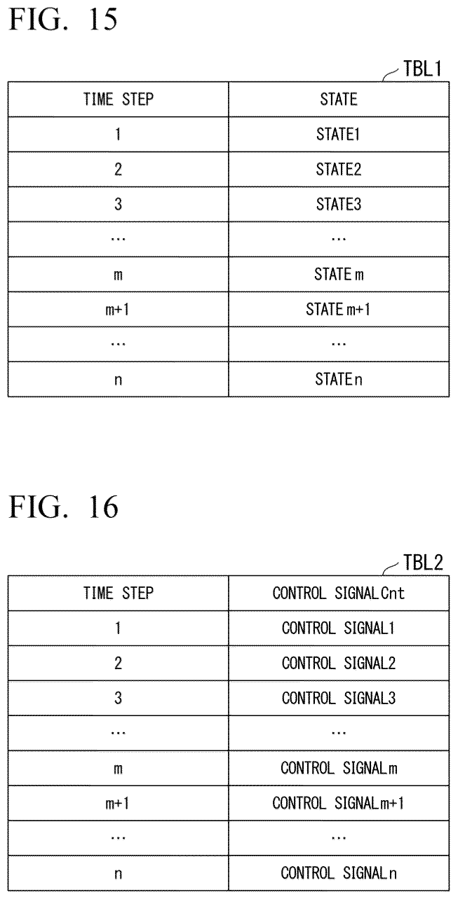

FIG. 15 is a diagram showing an example of an initial plan sequence TBL1 generated by the generation unit 202 according to the example embodiment of the present disclosure. For example, as shown in FIG. 15, the initial plan sequence TBL1 generated by the generation unit 202 is, for example, a sequence indicating a state of the robot 40 for each time step n from the movement source to the movement destination of the target object M.

The control unit 203 generates a control signal for controlling the robot 40 based on the sequence generated by the generation unit 202. That is, the control signal for implementing the posture of the target object M and the movement path of the target object M according to the sequence generated by the generation unit 202 is generated. The control unit 203 outputs the generated control signal to the robot 40.

FIG. 16 is a diagram showing an example of an initial plan control signal Cnt generated by the control unit 203 according to a first example embodiment of the present disclosure. For example, as shown in FIG. 16, the initial plan control signal Cnt generated by the control unit 203 is, for example, a control signal for each time step n from the movement source to the movement destination of the target object M.

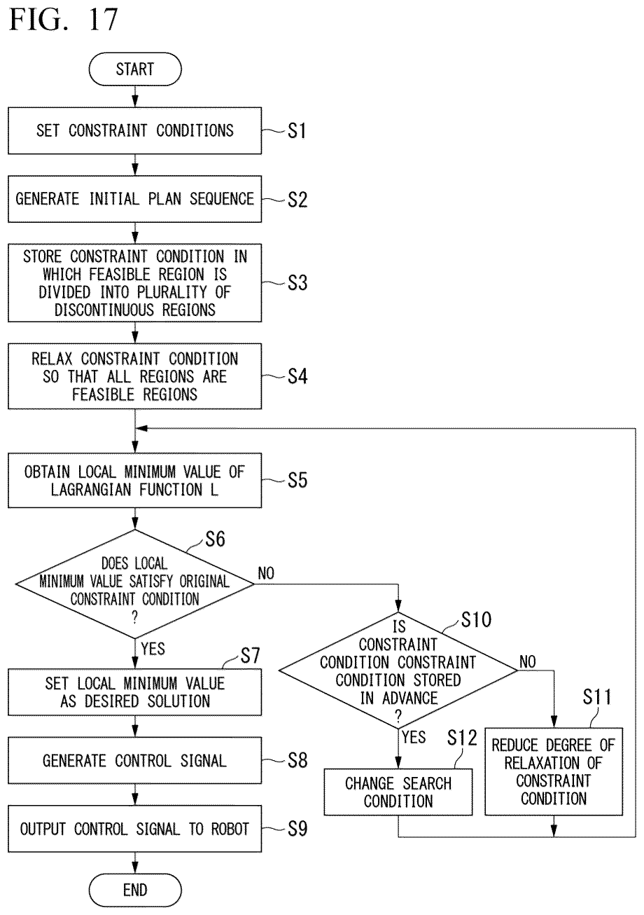

FIG. 17 is a diagram showing an example of a processing flow of the robot system 1 according to the example embodiment of the present disclosure. Here, a process of generating a sequence performed by the robot system 1 and controlling the robot 40 will be described with reference to FIG. 17. Here, it is assumed that each of the first processing unit 202a, the second processing unit 202b, and the third processing unit 202c performs the above-described process.

The fourth processing unit 202d sets various constraint conditions (step S1). For example, the fourth processing unit 202d sets a condition for a face of a target object M, which is included in constraint conditions for deciding a posture of the target object M and a movement path of the target object M and related to a grasp of the target object M, release of the grasp of the target object M, or a switching of the target object M from one robot arm to another robot arm, according to an expression using an outer product of a vector (an example of a first vector) indicating a direction in which the target object M is grasped and an x-axis vector (an example of a second vector), a y-axis vector (an example of the second vector) and a z-axis vector (an example of the second vector) for defining the posture of the target object M.

The fifth processing unit 202e generates an initial plan sequence indicating a flow of an operation of the robot 40 based on a task goal determined by processes of the first processing unit 202a, the second processing unit 202b, and the third processing unit 202c and constraint conditions set in a process of the fourth processing unit 202d (step S2). For example, the fifth processing unit 202e acquires the task goal from the first processing unit 202a, the second processing unit 202b, and the third processing unit 202c. Moreover, the fifth processing unit 202e acquires the constraint conditions from the fourth processing unit 202d. The fifth processing unit 202e adds the constraint conditions acquired from the fourth processing unit 202d to the constraint conditions input from the input unit 201. Also, the fifth processing unit 202e generates information indicating a state of the robot 40 for each time step during the process from a state of the target object M in a movement source to a state of the target object M in a movement destination necessary to generate a control signal for controlling the robot 40 in the control unit 203 based on the acquired task goal and constraint conditions (a type of the target object M, a position and posture of the robot 40, the strength of a grasp of the target object M, an operation of the robot 40 (e.g., an approach operation for moving toward the target object M (corresponding to the processing of an approach step in FIG. 11), a pick operation for grasping the target object M (corresponding to the processing of a pick step in FIG. 11), a carry operation for moving an arm for correctly moving the grasped target object M to a transport destination (corresponding to the processing of a carry step in FIG. 11), or a place operation for releasing the grasp of the target object M (corresponding to the processing of a place step in FIG. 11)), or the like).

For example, the fifth processing unit 202e decides a posture and movement path of the target object M for each time step according to simulation. Specifically, the fifth processing unit 202e may obtain a solution by using Lagrange's undetermined multiplier method for the Lagrangian function L. More specifically, the fifth processing unit 202e repeatedly searches for a region that satisfies the constraint condition and that has a local minimum value by differentiating the Lagrangian function L, thereby identifying a desired solution in which the objective function f(x, y) is a minimum.

Moreover, even if a non-convex constraint problem occurs, the fifth processing unit 202e uses the SA method to efficiently obtain the desired solution. Specifically, the fifth processing unit 202e stores a constraint condition in which the feasible region is divided into a plurality of discontinuous regions due to an infeasible region obtained in advance (step S3). Also, as shown in the part (a) of FIG. 14, the fifth processing unit 202e relaxes the constraint conditions so that all regions are feasible regions (step S4). In a state in which this constraint condition is relaxed, the fifth processing unit 202e obtains a local minimum value of the Lagrangian function L by differentiating the Lagrangian function L (step S5). Also, the fifth processing unit 202e determines whether or not this local minimum value satisfies the original constraint conditions (step S6). In a case where it is determined that the local minimum value satisfies the original constraint condition (YES in step S6), the fifth processing unit 202e sets the local minimum value as the desired solution (step S7). Also, the control unit 203 generates a control signal for controlling the robot 40 based on the sequence generated by the fifth processing unit 202e of the generation unit 202 (step S8). The control unit 203 outputs the generated control signal to the robot 40 (step S9).

Moreover, in a case where it is determined that the local minimum value does not satisfy the original constraint condition (NO in step S6), the fifth processing unit 202e determines whether or not the constraint condition is a constraint condition stored in advance (step S10). In a case where it is determined that the constraint condition is not a constraint condition stored in advance (NO in step S10), the fifth processing unit 202e reduces the degree of relaxation of the constraint condition (step S11). Also, the fifth processing unit 202e returns to the processing of step S5.

Moreover, in a case where it is determined that the constraint condition is a constraint condition stored in advance (YES in step S10), the fifth processing unit 202e changes a search condition by adjusting the degree of relaxation of the constraint condition (step S12). Also, the fifth processing unit 202e returns to the processing of step S5.

As described above, the fifth processing unit 202e generates an initial plan sequence indicating a flow of an operation of the robot 40 based on a task goal determined by processes of the first processing unit 202a, the second processing unit 202b, and the third processing unit 202c and a constraint condition set in a process of the fourth processing unit 202d. Therefore, for example, in the process of switching the target object M from one robot arm to another robot arm shown in the part (b) of FIG. 8, the fifth processing unit 202e (an example of a decision means) decides a direction in which the robot hand 403b (an example of a second grasping mechanism) grasps the target object M based on a direction of the face of the target object M being grasped by the robot hand 403a (an example of a first grasping mechanism). Moreover, the control unit 203 (an example of a control means) controls an operation of the robot hand 403b so that the robot hand 403b grasps the target object M in a direction in which the target object M is grasped decided by the fifth processing unit 202e.

Moreover, as described above, the fifth processing unit 202e generates an initial plan sequence indicating a flow of an operation of the robot 40 based on a task goal determined by processes of the first processing unit 202a, the second processing unit 202b, and the third processing unit 202c and constraint conditions set in a process of the fourth processing unit 202d. Therefore, for example, in a process of switching the target object M from one robot arm to another robot arm shown in the part (b) of FIG. 8, the fifth processing unit 202e (an example of a decision means) decides a first direction in which the robot hand 403a (an example of a first grasping mechanism) grasps the target object M and a second direction in which the robot hand 403b (an example of a second grasping mechanism) grasps the target object M based on a direction of a face of the target object M. Moreover, the control unit 203 (an example of a control means) controls the operation of the robot hand 403a so that the robot hand 403a grasps the target object M in the first direction and controls the operation of the robot hand 403b so that the robot hand 403b grasps the target object M in the second direction.

### Advantages

As described above, the robot system 1 according to the example embodiment of the present disclosure has been described. In the robot system 1, the fourth processing unit 202d (an example of a constraint means) sets a condition for a face of a target object M, which is included in constraint conditions for deciding a posture of the target object M and a movement path of the target object M and related to a grasp of the target object M, release of the grasp of the target object M, or a switching of the target object M from one robot arm to another robot arm, according to an expression using an outer product of a vector (an example of a first vector) indicating a direction in which the target object M is grasped and an x-axis vector (an example of a second vector), a y-axis vector (an example of the second vector) and a z-axis vector (an example of the second vector) for defining the posture of the target object M. The control unit 203 (an example of the control means) controls at least one of the robot hand 403a (an example of a first grasping mechanism) and the robot hand 403b (an example of a second grasping mechanism) for grasping the target object M, releasing the grasp of the target object M, or switching the target object M from one robot arm to another robot arm using the face of the target object M decided based on the constraint condition set by the fourth processing unit 202d.

Thereby, the robot arm can be appropriately controlled in accordance with the state of the target object in the robot system 1.

Moreover, thereby, constraint conditions can be simply set using, for example, an outer product expression, in the robot system 1.

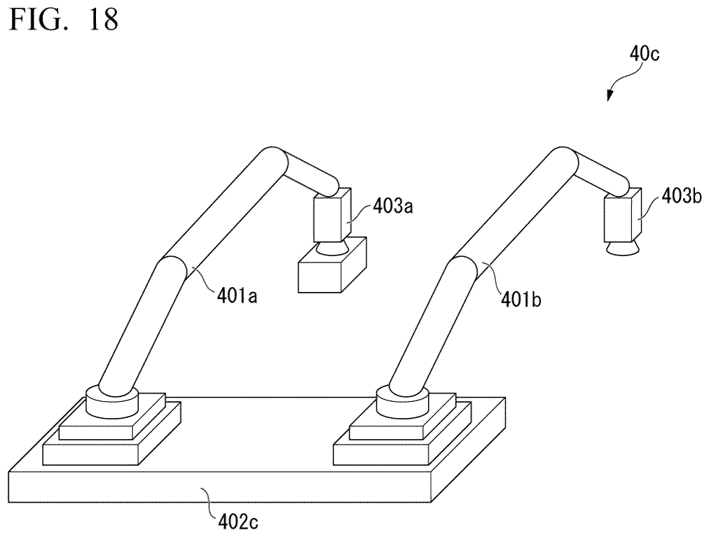

In addition, the case where the robot arm 401a and the robot hand 403a are included in the robot 40a and the robot arm 401b and the robot hand 403b are included in the robot 40b has been described in the example embodiment of the present disclosure. However, one robot may include a robot arm 401a, a robot hand 403a, a robot arm 401b, and a robot hand 403b in another example embodiment of the present disclosure. FIG. 18 is a diagram showing an example of a configuration of a robot 40c according to another example embodiment of the present disclosure. For example, the robot 40c includes the robot arm 401a, the robot arm 401b, a pedestal 402c, the robot hand 403a, and the robot hand 403b, as shown in FIG. 18. As in a process in which the control device 2 controls each of the robot arm 401a and the robot hand 403a provided in the robot 40a and the robot arm 401b and the robot hand 403b provided in the robot 40b in the example embodiment of the present disclosure, it is only necessary to control each of the robot arm 401a, the robot hand 403a, the robot arm 401b, and the robot hand 403b provided in the robot 40c.

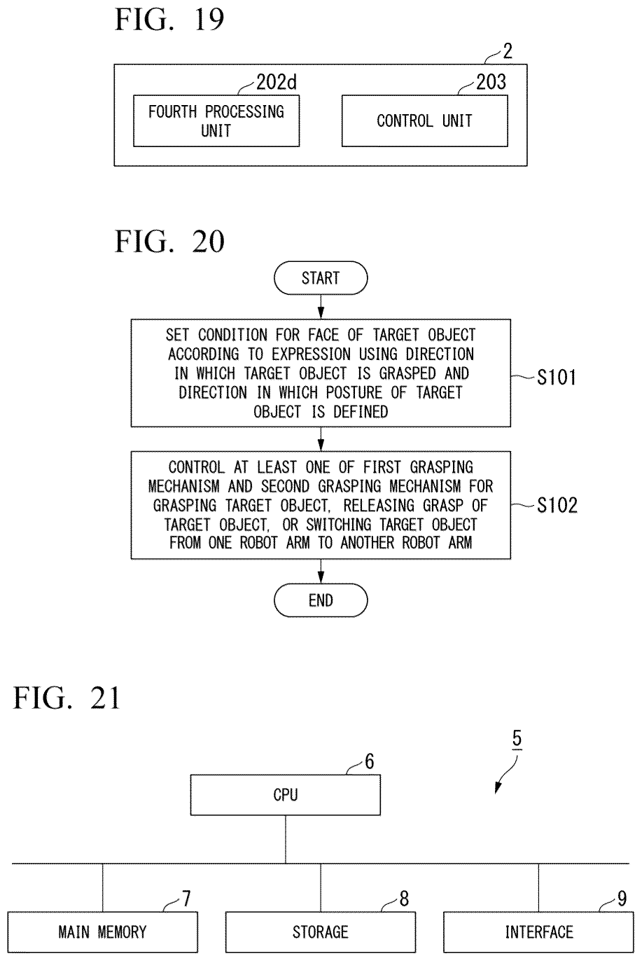

Next, the control device 2 having the minimum configuration according to the example embodiment of the present disclosure will be described. FIG. 19 is a diagram showing an example of the configuration of the control device 2 having the minimum configuration according to the example embodiment of the present disclosure. As shown in FIG. 19, the control device 2 having the minimum configuration according to the example embodiment of the present disclosure includes a fourth processing unit 202d (an example of a constraint means) and a control unit 203 (an example of a control means). The fourth processing unit 202d sets a condition for a face of a target object, which is included in constraint conditions for deciding a posture of the target object and a movement path of the target object and related to a grasp of the target object, release of the grasp of the target object, or a switching of the target object from one robot arm to another robot arm, according to an expression using a direction in which the target object is grasped and a direction in which the posture of the target object is defined. The fourth processing unit 202d can be implemented, for example, using the functions of the fourth processing unit 202d exemplified in FIG. 3. The control unit 203 controls at least one of the first grasping mechanism and the second grasping mechanism for grasping the target object, releasing of the grasp of the target object, or switching the target object from one robot arm to another robot arm using the face decided based on the condition set by the fourth processing unit 202d. The control unit 203 can be implemented, for example, using the functions of the control unit 203 exemplified in FIG. 2.

Next, the processing of the control device 2 having the minimum configuration according to the example embodiment of the present disclosure will be described. FIG. 20 is a diagram showing an example of a processing flow of the control device 2 having the minimum configuration according to the example embodiment of the present disclosure. Here, the process of the control device 2 having the minimum configuration will be described with reference to FIG. 20.

The fourth processing unit 202d (an example of a constraint means) sets a condition for a face of a target object, which is included in constraint conditions for deciding a posture of the target object and a movement path of the target object and related to a grasp of the target object, release of the grasp of the target object, or a switching of the target object from one robot arm to another robot arm, according to an expression using a direction in which the target object is grasped and a direction in which the posture of the target object is defined (step S101). The control unit 203 (an example of a control means) controls at least one of the first grasping mechanism and the second grasping mechanism for grasping the target object, releasing the grasp of the target object, or switching the target object from one robot arm to another robot arm using the face decided based on the condition set by the fourth processing unit 202d (step S102).

As described above, the control device 2 having the minimum configuration according to the example embodiment of the present disclosure has been described. The control device 2 can appropriately control the robot arm in accordance with the state of the target object in the robot system.

In the process in the example embodiment of the present disclosure, the order of the processing may be changed in a range in which an appropriate process is performed.

Although example embodiments of the present disclosure have been described, the above-described robot system 1, the control device 2, the input unit 201, the generation unit 202, the control unit 203, the robot 40, the image device 50, and other control devices may have a computer device therein. The process of the above-described processing is stored on a computer-readable recording medium in the form of a program, and the above process is performed by the computer reading and executing the program. A specific example of the computer is shown below.

FIG. 21 is a schematic block diagram showing a configuration of a computer according to at least one example embodiment. As shown in FIG. 21, a computer 5 includes a central processing unit (CPU) 6, a main memory 7, a storage 8, and an interface 9. For example, each of the above-described robot system 1, the control device 2, the input unit 201, the generation unit 202, the control unit 203, the robot 40, the image device 50, and other control devices is installed in the computer 5. Also, the operation of each processing unit described above is stored in the storage 8 in the form of a program. The CPU 6 reads the program from the storage 8, loads the program into the main memory 7, and executes the above-described process in accordance with the program. Moreover, the CPU 6 secures a storage area corresponding to each of the above-described storage units in the main memory 7 in accordance with the program.

Examples of the storage 8 include a hard disk drive (HDD), a solid-state drive (SSD), a magnetic disk, a magneto-optical disk, a compact disc read-only memory (CD-ROM), a digital versatile disc read-only memory (DVD-ROM), a semiconductor memory, and the like. The storage 8 may be an internal medium directly connected to a bus of the computer 5 or an external medium connected to the computer 5 via the interface 9 or a communication line. Also, in a case where the above program is distributed to the computer 5 via a communication line, the computer 5 receiving the distributed program may load the program into the main memory 7 and execute the above process. In at least one example embodiment, the storage 8 is a non-transitory tangible storage medium.

Moreover, the program may be a program for implementing some of the above-mentioned functions. Furthermore, the program may be a file for implementing the above-described function in combination with another program already stored in the computer system, a so-called differential file (differential program).

Although several example embodiments of the present disclosure have been described, these example embodiments are examples and do not limit the scope of the present disclosure. In relation to these example embodiments, various additions, omissions, substitutions, and other modifications can be made without departing from the spirit or scope of the present disclosure.

Although some or all of the above-described example embodiments may also be described as in the following supplementary notes, the present disclosure is not limited to the following supplementary notes.

### Supplementary Note 1

A control device including:
a constraint means configured to set a condition for a face of a target object, which is included in constraint conditions for deciding a posture of the target object and a movement path of the target object and related to a grasp of the target object, release of the grasp of the target object, or a switching of the target object from one robot arm to another robot arm, according to an expression using a direction in which the target object is grasped and a direction in which the posture of the target object is defined; and a control means configured to control at least one of a first grasping mechanism and a second grasping mechanism so that the target object is grasped, the grasp of the target object is released, or the target object is switched from one robot arm to another robot arm using the face decided based on the condition set by the constraint means.

### Supplementary Note 2

The control device according to supplementary note 1, wherein the constraint means relaxes the condition so that there is a local optimal solution in a case where there is no local optimal solution in a search for an optimal solution for the face, obtains the local optimal solution for the relaxed condition, reduces a degree of relaxation of the condition in a case where the obtained local optimal solution is not a desired solution, and obtains the local optimal solution for the condition whose degree of relaxation is reduced.

### Supplementary Note 3

The control device according to supplementary note 2, wherein the constraint means relaxes the condition so that there is a local optimal solution using a simulated annealing (SA) method, obtains the local optimal solution for the relaxed condition, reduces a degree of relaxation of the condition in a case where the obtained local optimal solution is not a desired solution, and obtains the local optimal solution for the condition whose degree of relaxation is reduced.

### Supplementary Note 4

The control device according to supplementary note 2 or 3, wherein the constraint means changes content of the relaxation in a case where the relaxed condition is a condition in which a previously obtained local optimal solution is not obtained, obtains a local optimal solution for the condition relaxed in the changed content, reduces a degree of relaxation of the condition in a case where the obtained local optimal solution is not a desired solution, and obtains the local optimal solution for the condition whose degree of relaxation is reduced.

### Supplementary Note 5

A robot system including:
a first grasping mechanism;
a second grasping mechanism; and
the control device according to any one of supplementary notes 1 to 4.

### Supplementary Note 6

A control method including:
setting a condition for a face of a target object, which is included in constraint conditions for deciding a posture of the target object and a movement path of the target object and related to a grasp of the target object, release of the grasp of the target object, or a switching of the target object from one robot arm to another robot arm, according to an expression using a direction in which the target object is grasped and a direction in which the posture of the target object is defined; and
controlling at least one of a first grasping mechanism and a second grasping mechanism so that the target object is grasped, the grasp of the target object is released, or the target object is switched from one robot arm to another robot arm using the face decided based on the set condition.

### Supplementary Note 7

A recording medium storing a program for causing a computer to:
set a condition for a face of a target object, which is included in constraint conditions for deciding a posture of the target object and a movement path of the target object and related to a grasp of the target object, release of the grasp of the target object, or a switching of the target object from one robot arm to another robot arm, according to an expression using a direction in which the target object is grasped and a direction in which the posture of the target object is defined; and
control at least one of a first grasping mechanism and a second grasping mechanism so that the target object is grasped, the grasp of the target object is released, or the target object is switched from one robot arm to another robot arm using the face decided based on the set condition.

### Supplementary Note 8

A control device including:
a decision means configured to decide a direction in which a second grasping mechanism grasps a target object based on a direction of a face of the target object grasped by a first grasping mechanism; and
a control means configured to control an operation of the second grasping mechanism so that the target object is grasped in the direction decided by the decision means.

### Supplementary Note 9

A control device including:
a decision means configured to decide an operation in which a first grasping mechanism and a second grasping mechanism grasp a target object based on a grasping direction of the first grasping mechanism, a grasping direction of the second grasping mechanism, and a direction of a face of the target object; and
a control means configured to perform a control process so that the first grasping mechanism and the second grasping mechanism perform the decided operation.

### INDUSTRIAL APPLICABILITY

According to the example aspects of the present disclosure, it is possible to appropriately control a robot arm in accordance with a state of a target object in a robot system.

### REFERENCE SIGNS LIST

1 Robot system
2 Control device
5 Computer
6 CPU
7 Main memory
8 Storage
9 Interface
40 Robot
50 Image device
201 Input unit
202 Generation unit
202a First processing unit
202b Second processing unit
202c Third processing unit
202d Fourth processing unit
202e Fifth processing unit
203 Control unit
C Cardboard box
F Floor
M Target object
T Tray

What is claimed is:

1. A controller comprising:
a memory configured to store instructions; and
a processor configured to execute the instructions to:
set a condition for a face of a target object according to an expression using a direction in which the target object is grasped and a direction in which a posture of the target object is defined, the condition being included in constraint conditions for deciding the posture of the target object and a movement path of the target object and related to a grasp of the target object, release of the grasp of the target object, or a switching of the target object from one robot arm to another robot arm; and
control at least one of a first robot hand or a second robot hand so that the target object is grasped, the grasp of the target object is released, or the target object is switched from one robot arm to another robot arm using the face decided based on the condition.

2. The controller according to claim 1, wherein the processor relaxes the condition so that there is a local optimal solution in a case where there is no local optimal solution in a search for an optimal solution for the face, obtains the local optimal solution for the relaxed condition, reduces a degree of relaxation of the condition in a case where the obtained local optimal solution is not a desired solution, and obtains the local optimal solution for the condition whose degree of relaxation is reduced.

3. The control according to claim 2, wherein the processor relaxes the condition so that there is a local optimal solution using a simulated annealing (SA) method, obtains the local optimal solution for the relaxed condition, reduces a degree of relaxation of the condition in a case where the obtained local optimal solution is not a desired solution, and obtains the local optimal solution for the condition whose degree of relaxation is reduced.

4. The controller according to claim 2, wherein the processor changes content of the relaxation in a case where the relaxed condition is a condition in which a previously obtained local optimal solution is not obtained, obtains a local optimal solution for the condition relaxed in the changed content, reduces a degree of relaxation of the condition in a case where the obtained local optimal solution is not a desired solution, and obtains the local optimal solution for the condition whose degree of relaxation is reduced.

5. A robot system comprising:
a first robot hand;
a second robot hand; and
the controller according to claim 1.

6. A control method comprising:
setting a condition for a face of a target object according to an expression using a direction in which the target object is grasped and a direction in which a posture of the target object is defined, the condition being, included in constraint conditions for deciding the posture of the target object and a movement path of the target object and related to a grasp of the target object, release of the grasp of the target object, or a switching of the target object from one robot arm to another robot arm; and
controlling at least one of a first robot hand or a second robot hand so that the target object is grasped, the grasp of the target object is released, or the target object is switched from one robot arm to another robot arm using the face decided based on the set condition.

7. (canceled)

8. A controller comprising:
a memory configured to store instructions; and
a processor configured to execute the instructions to:
decide a direction in which a second robot hand grasps a target object based on a direction of a face of the target object grasped by a first robot hand; and
control an operation of the second robot hand so that the target object is grasped in the direction.

9. (canceled)

10. The controller according to claim 1, wherein the processor controls robot arms so that the target object is switched from one robot arm to another robot arm.
